(19) United States
(12) Patent Application Publication
(10) Pub. No.: US 2003/0231799 A1
(43) Pub. Date: Dec. 18, 2003

(54) Lossless data compression using constraint propagation

(76) Inventor: Craig Schmidt, Somerville, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/172,545

(22) Filed: Jun. 14, 2002

(51) Int. Cl. G06K 9/36

(52) U.S. Cl. 382/244

(57) ABSTRACT

A computer-implemented system and method for compressing and decompressing data. According to one embodiment of the invention, a method of lossless compression of a sequence of data points is provided. The method comprises acts of determining limits on a data point based on available data, predicting a possible value for that data point, limiting the predicted value to the determined limits and encoding a function of the predicted value and the data point. Such encoded function may later be stored or transmitted and may be of smaller size than the original data set. The original data set may be comprised of a sequence of sampled continuous wave data points, such as, for example, time-sampled music data points. A corresponding method for decompression of encoded data may be provided.

### FIELD OF INVENTION

This application pertains to data compression, and, more specifically, to a method and a system for lossless compression and decompression of time-sampled digital data.

### BACKGROUND

Most of the data transmitted over the Internet is transmitted in a compressed form in order to conserve bandwidth and transmission time, as well as space on the storage media required to store the data. Various compression and decompression algorithms have been created; some are general in nature, and some depend heavily on the particular type of data being manipulated.

In general, compression may be described as an attempt to minimize, on average, the size of a data set by utilizing information known apriori to compression and decompression systems. Such information may be, for example, known algorithms or constraints, or a collection of data from which at least a portion of the original data set may be assembled. The efficiency of compression may be measured by a compression ratio—a ratio of size of an uncompressed data set to size of a compressed data set.

Compression may be “lossless” or “lossy.” In lossless compression, no information is lost in compression—that is, when decompressed, the data set has the same information as before the compression. In lossy compression, some information may be lost during compression, such that the decompressed data set may not carry the same amount of information as the initial data set. The term “lossy” comes from the fact that some information may be lost in the process. A lossy algorithm is typically designed in such a manner that the information that is lost is not critical. For example, the human ear is more sensitive to certain frequencies than others, and a lossy compression technique may take advantage of that by eliminating data in the less-heard frequencies. While some information may be lost, many people may not be able to detect the difference when playing the compressed audio file.

A lot of attention has been paid to compression of media data such as, for example, music or video files. Although the present invention is particularly applicable to media data, it may be used with any digital data, especially data representing continuous wave forms. Such digital data is often sampled at specified time intervals. The most common example of this type of data is a Compact Disc (CD), which uses 16-bit samples taken at evenly spaced time intervals 44,100 times per second. The 16-bit sample may be represented by an integer between −32768 and 32767. Other examples of this form of data include electrocardiogram (EKG) signals and pressure and temperature data from industrial instruments.

With respect to the media data, and, especially, music data, there are several well-known standards for compression. The most popular ones typically use lossy methods in order to achieve high compression ratios. For example, the well known MP3 format (Brandenburg and Stoll, 1994), can usually compress a CD by a factor of 4 to a factor of 20, depending on the desired sound quality. While such high compression ratios are highly desirable, in order to achieve them, a significant amount of information may be lost, thus sacrificing sound quality. Therefore, a lossless method that achieves relatively high compression ratios on a large number of data sets is desired.

### SUMMARY

A system and a method are provided for compressing and decompressing data. According to one embodiment of the invention, a method of lossless compression of a sequence of data points is provided. The method comprises acts of determining limits on a data point based on available data, predicting a possible value for that data point, limiting the predicted value to the determined limits and encoding a function of the predicted value and the data point. Such encoded function may later be stored or transmitted and may be of smaller size than the original data set. The original data set may be comprised of a sequence of sampled continuous wave data points, such as, for example, time-sampled music data points.

The limits may be determined based on already-processed data points through determining constraints on the data point satisfied by the data point. Such constraints may be, for example, linear programming constraints, and determining limits may comprise solving linear programs in order to determine minimum and maximum values for the data point that satisfy the linear programming constraints. The constraints may be selected from a set of available constraints, such that they are satisfied by the data point. An indication of which set of constraints has been selected may be encoded and stored along with the compressed data.

Predicting possible values for the data point may comprise selecting most likely value of the data point based on a subset of previously-processed data points. Such most likely values may be determined by one or more polynomial functions. In order to pick one possible value, a particular polynomial predictor may be picked from the available predictors. The predictor may be selected on the basis of the previous performance, such as, for example, success in predicting values of previously-processed data points. After each prediction, an indication may be kept of past performance of all or a subset of predictive functions.

Encoding of the function of the predicted value and the data point may be accomplished according to any number of known encoding schemes, such as, for example, prefix codes. In order to use a prefix code, a coding table may be selected from a list of available coding tables. A rank may be computed for the data point, such that the rank is a function of the predicted value, the data point, and the determined limits, and the rank may be encoded based on the prefix coding table. Encoding the rank may limit the size of the transferred information as well as allowing a single alphabet to be used for each encoding table.

According to another aspect of the invention, provided is a method for decompressing a compressed sequence of data points. The method comprises acts of determining limits based on available data, predicting value for a data point, limiting the data to the determined limits, decoding an encoded function of the predicted value and the data point, and obtaining the data point from the function of the predicted value and the data point. The method for decompressing may be applied to any kind of digital data, in particular to audio data of time-sampled audio data points.

Limits may be determined based on a set of linear constraints. The set of linear constraints may be selected from available sets based on a selector stored with the compressed data. Two linear programs may be solved in order to determine a minimum and a maximum values for the data point based on the set of selected constraints.

Predicting the value for the data point may be accomplished by one of the predictor functions. Predictor functions may be polynomial functions, and one of them may be selected to give the actual predictor value. Selection of the polynomial functions may be accomplished based on their performance on previous data points, such as, for example, by selecting the function that has performed best on previous samples.

According to yet another aspect of the invention, a system is provided for lossless compression of a sequence of data points. The system may comprise a limit module for determining limits based on available data, a predictor for predicting a value for a data point, where the predicted value is limited to the determined limits, and an encoder for encoding a function of the predicted value and the data point. Correspondingly, according to another aspect of the invention, a system is provided for decompression of a sequence of compressed data points. The decompression system may comprise a limit module for determining limits based on available data, a predictor for predicting a value for a data point, where the predicted value is limited to the determined limits, and a decoder for decoding a data point based on the encoded function of the predicted value and the data point.

The limit and predictor modules of the compression and decompression systems may be based on similar principles. The limit module may determine limits on the data point based on a set of linear constraints satisfied by the data point. The limit module may determine the limits by solving one or more linear programs in order to determine minimum and maximum values satisfying the linear constraints.

The predictor module may predict the value of the data point by executing a linear function. Such a linear function may be extrapolating the predicted value based on a subset of previously-processed data points. The linear function may be one of several available linear functions, selected because it has provided best predictions for previous data points.

According to yet another aspect of the invention, provided is a stream of data comprising data points encoded by determining limits based on available data, predicting value for a data point, and encoding a function of the predicted value and the data point. Such a stream may be a sequence of continuous wave data points, such as, for example, audio data points.

According to yet another aspect of the invention, provided is a method for encoding data. The method for encoding comprises determining a range of values of a data point, selecting a prefix coding table based on the determined range, and encoding a function of the data point according to the selected prefix table. The range may be determined by solving a linear program in order to determine a minimum and a maximum values satisfied by linear constraints.

According to yet another aspect of the invention, a method for lossless encoding of a stream of sampled music data points is provided. The method comprises determining limits based on available data, performing intra-channel decorrelation (see FIG. 4) on a data point, limiting results of the intra-channel decorrelation to the determined limits, and encoding results of the intra-channel decorrelation.

The limits may be determined by solving linear programs for a minimum and a maximum values satisfying a set of linear constraints. The set of linear constraints may be selected from other available sets of linear constraints because it is satisfied by the data point.

Intra-channel decorrelation may comprise predicting a value for the data point. Prediction may be accomplished by one of the predictor functions. Alternatively, a transform of the data point may be calculated.

Encoding results of the intra-channel decorrelation may be accomplished by using a prefix coding table. The prefix coding table may be selected from available prefix coding tables based on range of the determined limits.

### BRIEF DESCRIPTION OF THE DRAWINGS

In the drawings:

FIG. 1 is a schematic representation of a prior art compression system;

FIG. 2 is a diagram illustrating possible prediction error for an adaptive polynomial predictor;

FIG. 3 is a schematic representation of the illustrative embodiment of the invention;

FIG. 4 is a flow chart illustrating data compression;

FIG. 5 is a flow chart illustrating rank computation;

FIG. 6 is a schematic illustration of sample computed ranks;

FIG. 7 is a flow chart illustrating data decompression;

FIG. 8 is a flow chart illustrating value extraction.

### DETAILED DESCRIPTION

The following detailed description should be read in conjunction with the attached drawings in which similar reference numbers indicate similar structures.

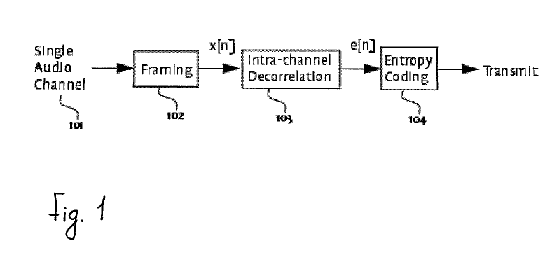

The present invention is concerned with lossless compression of digital data sets. While in FIGS. 1-8, and the following description, reference is made to music data set, the present invention is not limited to music or media data and may be applied to any other data set, such as, for example, EKG data, as deemed appropriate by one skilled in the art.

Illustrated in FIG. 1 is a prior art system for lossless compression of music data. An input to a compression system may be a digitally encoded single audio channel 101, represented as a set of data samples. Such audio channel may be one of many representing a particular music piece. In act 102, channel 101 may be divided into frames.

Each frame contains a fixed number of samples and may be compressed independently of other frames. There are standards defining the size of the frames as applicable to a particular data format. For example, for CD quality sound, a single frame commonly consists of 1152 samples. The present invention is not limited to frames of a particular size, and, in general, variable N may be used to represent the total number of samples in each frame. An individual sample at location n in the frame may be called x[n], so that, if samples in a frame are numbered starting from 0, the frame will contain samples x[0] through x[N−1].

In act 103, predictions for possible values of a point are used to compress that point. Using predicted values to compress data points is referred to as “intra-channel decorrelation.” The term “prediction” is used broadly herein and may refer to determining a predictive value p[n] for a sample x[n], where p[n] may be known to be equal to x[n] or a value predicted based on other available data. Prediction value p[n] may be, for example, a transform of x[n]. If a similar prediction can be made by encoding and decoding modules, a difference between the prediction and the actual value of the sample may be encoded, rather than the actual value. Such a difference, called an “error”, is typically smaller than the actual value and therefore can be encoded more efficiently, thus reducing the size of each data point and assuring compression of the data set. The error, e[n] for each sample x[n] may be defined as follows: e[n]=x[n]−p[n].

A common prediction mechanism utilizes some or all values x[0]through x[n−1] in order to predict the value of x[n]. Underlying data properties may be exploited in order to improve prediction. For example, sound waves typically form fairly smooth curves, and previous sampled values may be used in order to extrapolate a predicted value p[n]. Hence, for example, a linear or a low order polynomial function may be used as a prediction function. In some applications, a zero order predictor may be used, making p[n]=x[n−1].

Errors e[n] are encoded in act 104, completing the compression process. While typically prediction functions are designed in order to minimize the errors (and thus to minimize the compressed data set), the prior art systems use extrapolation for prediction, which can have large errors. On a random data set, for example, such compression may result in a data set that is larger than the uncompressed data set.

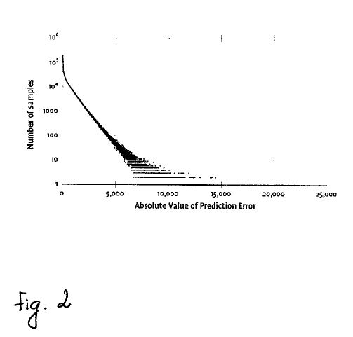

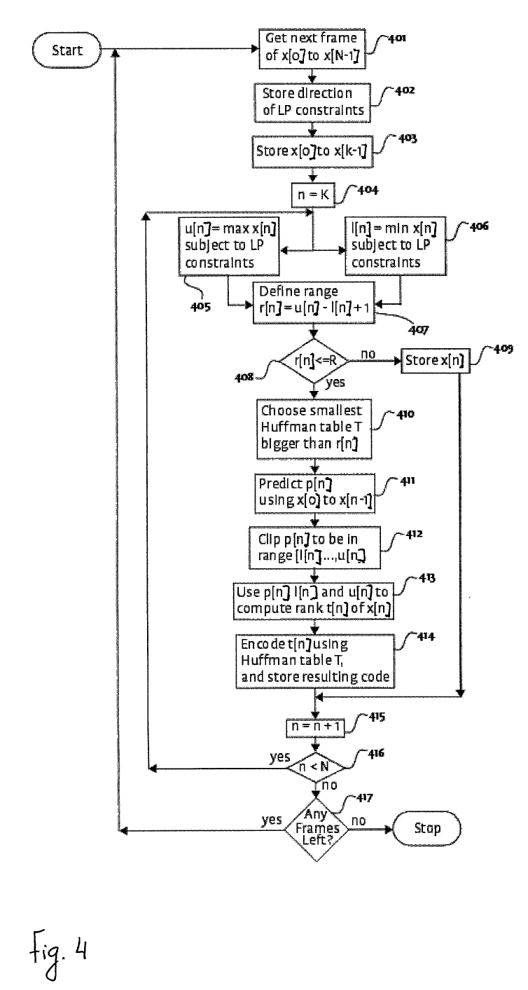

Prediction errors for an adaptive polynomial predictor (see FIG. 4) are illustrated in FIG. 2. This graph shows the number of samples with a given absolute value of a prediction error. Although the size of errors decreases exponentially as the number of samples increases, there is still a “tail” to the distribution, indicating large errors that may significantly lower the compression ratio. Therefore, one of the goals of a compression scheme is to curtail the errors.

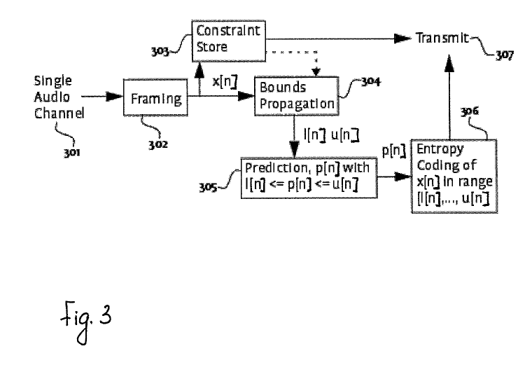

FIG. 3 is a schematic representation of the illustrative embodiment of the invention. Shown is encoding of a single audio channel 301. Framing 302 may proceed in a manner described above with a predetermined number of samples per track or in any other implementation as deemed appropriate by one skilled in the art. The present invention is not limited to a particular framing method. Furthermore, an alternative embodiment of the invention may forego framing.

To improve the prediction function and bound the range of prediction errors to encode, the illustrative embodiment of the invention uses a set of constraints that are satisfied by all or a subset of samples x[n] in the frame. In a particular frame, the set of constraints to be used may be determined in act 303. Selection of constraints is described below in connection with FIG. 4.

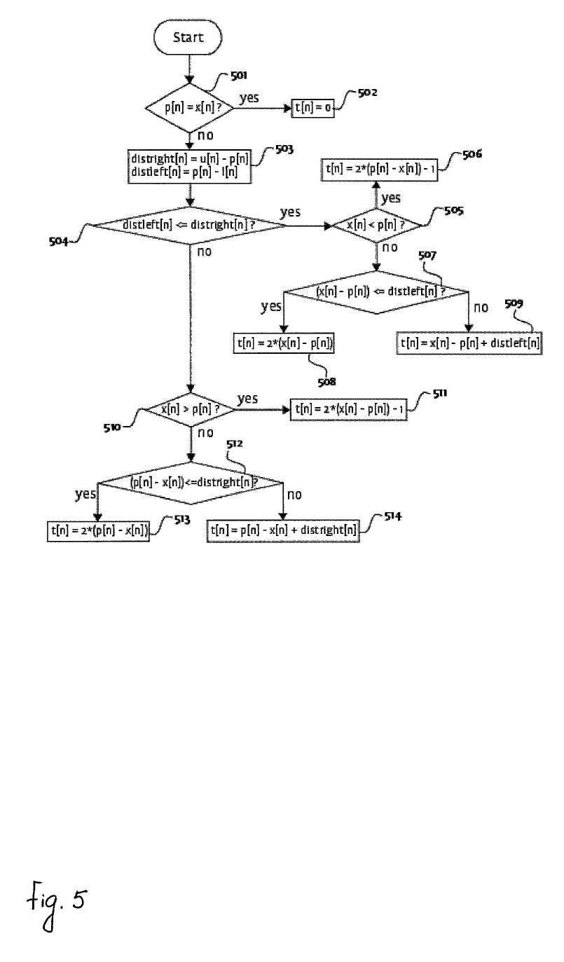

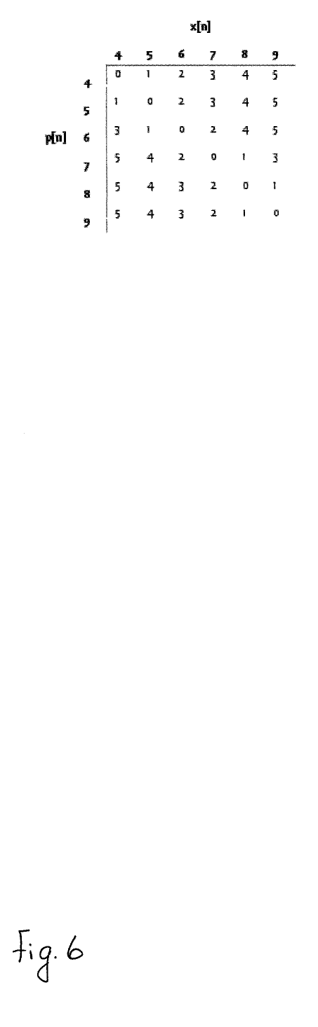

In act 304, limits are determined for values of samples x[n]. Such limits may be determined using any linear or non-linear programming algorithm to compute the minimal values of x[n] (which we will call [n] or the lower bound of x[n]) and the maximum value of x[n] (which we will call u[n] or the upper bound of x[n]) subject to the set of constraints mentioned above for each n from k to N−1, for some K. Predictors p[n] for values x[n] are determined in act 305. Predictors may be limited to the limits determined in act 304, such that for each n, where n>=k, l[n]<=p[n]<=u[n]. In such a way a prediction may be limited to a particular range. The range may be significantly smaller than the total available range of values, thus limiting the size of the data point in the compressed data set. Prediction is further described in connection with FIG. 4. Limiting the size of the prediction is described in connection with FIGS. 5 and 6.

A function of predicted values and errors may be encoded in act 306. Encoding may be an entropy encoding or any other method of encoding known to one skilled in the art. Entropy encoding is described in further detail in connection with FIG. 4.

Encoded values and indications of selected constraints may be transmitted in act 307 or stored in media, as appropriate for a particular embodiment of the invention.

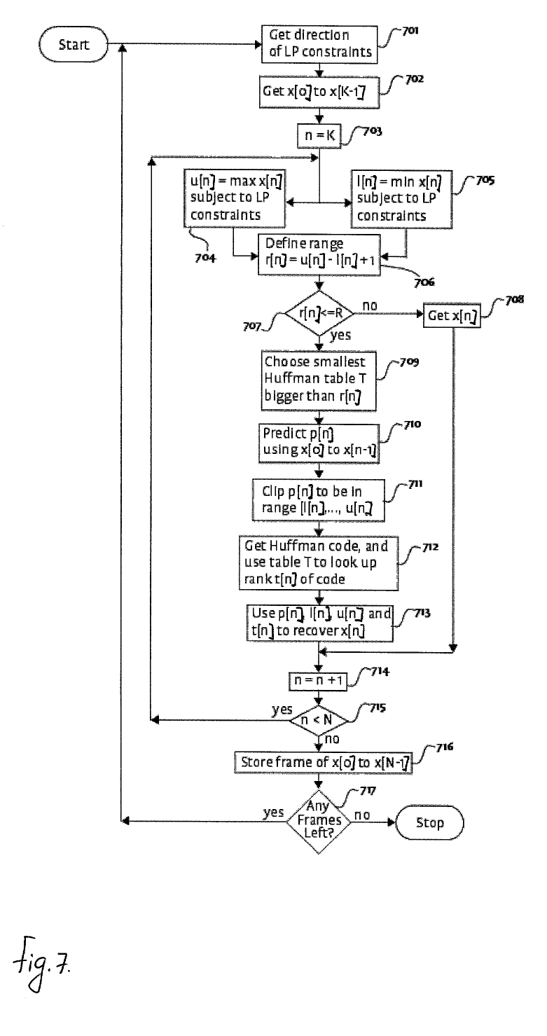

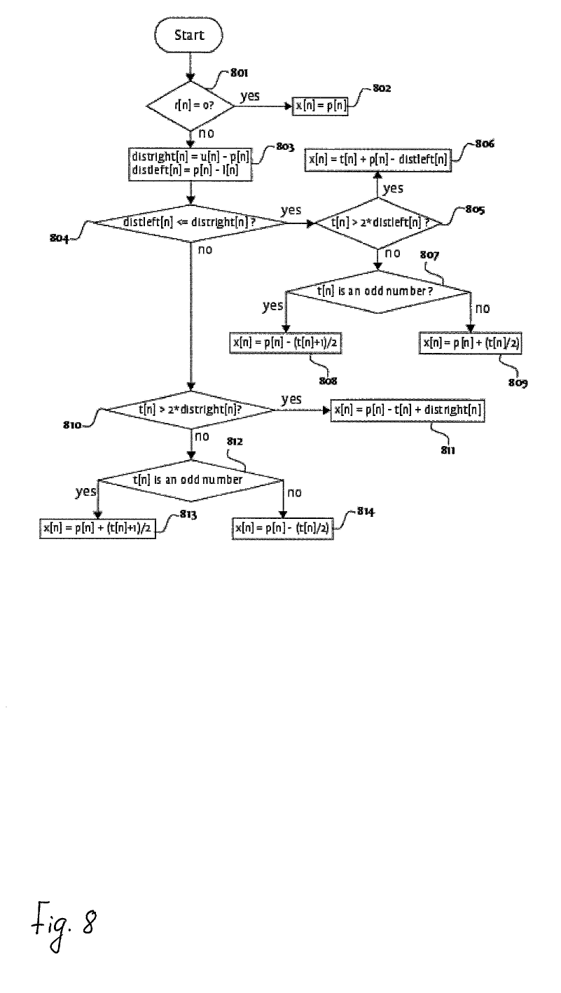

FIG. 4 is a flowchart of acts involved in compressing a stream of data. Such compression may be implemented in software or hardware, or a combination of software and hardware, as deemed appropriate by one skilled in the art. Corresponding decompression scheme is described in connection with FIGS. 7 and 8.

Compression starts in act 400, where variables are initialized and data is prepared. A frame with sampled values x[0] to x[N−1] is loaded in act 401.

Constraints for the sampled values are determined and stored in act 402. Constraints may be of any type suitable for linear or non-linear programming and determination of limits or ranges of values. Linear programming constraints are used in the illustrative embodiment of the invention. A Linear Program may be generally expressed as a problem in the form of:

(FORM1) minimize cx

subject to Ax<=b

x>=0

and

(FORM2) maximize cx

subject to Ax<=b

x>=0

where x is a vector of variables to be solved for, A is a matrix of known coefficients, and c and b are vectors of known coefficients. The equations “Ax<=b” may be called constraints.

In the illustrative embodiment of the invention, constraints suitable for Linear Programming algorithms are used in order to limit the possible range of values of the sampled data. Any number of sets of constraints in the x[n] variables may be used, as determined by one skilled in the art.

A set of constraints can be selected such that all constraints are satisfied by the values of x[n], k<=n<N involved in the constraints. The selection of the constraints may then be encoded and stored to be later transmitted or stored with encoded values. A given constraint may be of the form:

$$\begin{matrix}{\sum }_{n = k}^{N - 1} A [ l , n ] x [ n ] \leq b [ l ] \\ or \\ & \text{(EQ1)} \\ {\sum }_{n = k}^{N - 1} A [ l , n ] x [ n ] > b [ l ] & ( EQ2 )\end{matrix}$$

The representative embodiment of the invention uses a fixed A matrix and b vector with L rows. A set of L constraints is selected by multiplying all values in some rows of A and b by −1 so that all the constraints are satisfied. Such multiplication is equivalent to selecting whether to use EQ1 or EQ2 independently for each constraint. Still in other words, it may be said that a “direction” of a constraint is thereby selected.

A selection may be encoded by an L-bit vector, with each bit indicating whether to multiply a particular row by −1 (selecting whether to use EQ1 or EQ2 for a particular row). Since a corresponding decompressing module may have the same A matrix and b vector available, only the indication of which rows to multiply by −1 may need to be transmitted to reconstruct the set of constraints used in encoding.

Matrix A and vector b may be selected by one skilled in the art to emphasize various properties of the compression scheme of the particular embodiment. For example, they may be selected such that there is a 50% probability that a given constraint is in the form of EQ1 and such that there are no correlations between directions of adjacent constraints.

In the illustrative embodiment, each x[n] may be involved in 5 to 25 constraints, but the invention is not limited to a particular set or size of constraints and may be modified as appropriate by one skilled in the art. In order to determine limits on samples x[k] to x[N−1], a number of samples x[0] to x[k−1] may be transmitted or stored in the uncompressed form in act 403. That is, their values may be encoded, stored, or transmitted outright, without the compression mechanism. In the illustrative embodiment of the invention, k may be from 5 to 25, to correspond to the number of constraints involved. In an alternative embodiment, k may vary as deemed appropriate. In yet another embodiment of the invention, an alternative compression method may be used for these samples.

In act 404, variable n, indicating the next sample x[n] to be compressed is initiated to K—that is, to the first non-stored (or transmitted) value.

Limits u[n] and l[n] are determined in acts 405 and 406, respectively. In the illustrative embodiment of the invention, two linear programs are solved to determine those limits. A linear program is solved in act 405 to maximize and in act 406 to minimize the value of x[n] subject to the constraints and simple bounds on variables. In the embodiment directed to compression of music samples, 16 bit samples must lie between −32768 and 32767, so these simple bounds may be added to the linear programs as well. In an alternative embodiment of the invention, bounds or constraints appropriate for a particular data set to be compressed may be added in addition to a predetermined set of constraints. In yet another embodiment of the invention, available data other than values of previous samples may also be used in order to limit the possible values of x[n].

There are numerous systems and methods for solving Linear and Non-Linear programs and determining limits on values satisfying a set of constraints. Such methods may be bounds propagation, constraint propagation, barrier or interior-point methods, etc. Some of the most popular methods for determining limits on variables are Simplex methods. The present invention is not limited to a particular method or system for solving linear or non-linear programs and may utilize any appropriate scheme as determined by one skilled in the art.

Values l[n] and u[n] may be integers, for example, in the time-sampled audio data context, because encoded samples are integers, however, the present invention is not limited to integer digital data and may be applied to any kind of digital data. Integer Linear Programming is typically more computationally-intensive, and therefore its use may be undesirable in some applications. In the illustrative embodiment of the invention, non-integer linear programming methods are used, and the found bounds are then rounded up or down, as appropriate, to integer limits. In an alternative embodiment of the invention, Integer Linear Programming techniques may be used to determine integer limits on values.

Range r[n]=u[n]−l[n]+1 is defined in act 407. This range represents size of a possible range of values for a particular x[n], as limited by limits u[n] and l[n]. For particular types of sampled data, r[n] for some values may be significantly smaller than the range of all available values for x[n], unconstrained by the limits. However, there may be cases where r[n] is fairly large, in which case it may be advantageous to store the actual value of x[n] rather than compressing it. In an alternative embodiment, one may store the actual value of e[n] if r[n] is fairly large instead of x[n]. The check for whether r[n] is larger than some predetermined range R is performed in act 408, and x[n] is stored in act 409 if the check returns a positive answer.

It must be noted that lossless compression of some data sets may result in compressed data sets that are larger or not significantly smaller than the original non-compressed data sets. For example, if predictive functions are geared towards smooth functions, compressing a data set consisting of random noise may result in an output that is larger than the input, because encoding of the predictive error e[n] may be larger than encoding of the x[n] itself due, for example, to the prefix codes that may be used to encode e[n]. Storing x[n] rather than the compressed encoding of x[n] in cases where r[n] is larger than R attempts to limit this potential increase in the size of the compressed data set. In an alternative embodiment of the invention, some or all values may be compressed, regardless of ranges. In yet another embodiment of the invention, an alternative compression scheme may be used for x[n] for which r[n] is larger than some predetermined R.

Determination of predictive values and encoding of errors is performed in acts 410 through 414. In the illustrative embodiment of the invention, so-called prefix codes may be used to encode those values. Prefix codes attempt to compress values by assigning a shorter encoding—to most frequently repeated values, and longer codes to less-frequently repeated numbers. The term “prefix code” refers to the fact that no code contains any other code as a prefix. This means that, given a stream of bits representing a sequence of codes, it is possible to unambiguously identity beginning and end of each code. There are numerous known prefix codes, such as, for example, well-known Huffman codes or Rice codes. Rice codes are Huffman codes for Laplacian probability distribution, which may be a close fit for the expected distribution of e[n] values for music data. The present invention is not limited to prefix codes. In an alternative embodiment of the invention, other types of encodings may be used.

Prefix codes use a special type of table (sometimes also referred to as a “tree” because a tree structure better expresses the relationship between data in the table) to determine encoding for a particular symbol. For clarity, all such tables are referred to as “Huffman tables” herein, even though they may be variations on a particular type of Huffman tables.

In order to further compress the data, more than one type of encoding may be used. For example, different ranges of values may be encoded differently, choosing the encoding that is most appropriate for a particular range of values. In the illustrative embodiment of the invention, there may be several Huffman tables of various sizes. Once the range is determined, a Huffman table of an appropriate size may be selected in act 410. For example, if stored are Huffman tables of sizes 4, 8, 16, 32, 64, 128, and 256, and some range r[n] is equal to 7, the Huffman table of size 8 may be picked in order to encode the predictive value in that range. Selecting tables of appropriate size limits the number of bits required to encode a particular value.

In order to encode x[n] with a range r[n], a Huffman table must contain at least r[n] symbols. While it would be possible to use a different Huffman table for each r[n], in the illustrative embodiment of the invention, a predetermined number of tables are pre-stored. A Huffman table with T symbols is selected from available tables in act 410, such that it is the smallest available table with T>=r[n]. The present invention is not limited to a particular set of encoding or Huffman tables. In an alternative embodiment, other encoding method and methods of selecting an appropriate encoding table may be used.

Predictive values p[n] are calculated in act 411. Such predictive values may be calculated from any available data, such as, for example, any subset of known values x[0] through x[n−1]. In the illustrative embodiment of the invention a linear or low order polynomial predictor may be used to predict x[n] from x[0] to x[n−1]. One or more functions may be used to make predictions.

In the illustrative embodiment of the invention, an adaptive scheme is used to improve the prediction capability. Several polynomial predictors are stored, and a predictor for a particular x[n] is chosen among them. For example, zero through sixth order polynomial predictors may be used. The predictor that is chosen may be the one that provided the best predictions for previous values.

A weight w[j] may be computed for each predictor j and updated after each prediction. Initially wall w[j] are initialized to 1.0. For each x[n], the predictor j with the highest weight w[j] may be used in act 411 to predict the value of x[n]. After use, the remaining predictors and prediction errors may also be computed in order to provide basis for updating of the weights. The weights of the predictors j may be then updated according to the formula:

w[j]=a*w[j]+(1.0−abs(error[j]−minerror)/(maxerror−minerror))

where minerror and maxerror are the minimum and maximum error of any predictor for x[n], correspondingly, and a is a predetermined parameter. In the illustrative embodiment of the invention, a may be assigned between 0.6 and 0.99. Calculation of which predictor to use is not limited to a particular formula and may be performed as appropriate for a particular embodiment of the invention.

Predicted value p[n] may lie outside determined limits l[n] and u[n]. For example, if the zero order predictor was used, and x[n−1] is very different from x[n], p[n] will likely be outside the determined limits. However, such predicted values may be limited—or “clipped”—to the determined limits, because the actual value lies within the limits. The clipping may be accomplished so that if p[n]>u[n], then p[n]=u[n], and if p[n]<l[n], then p[n]=l[n]. In an alternative embodiment of the invention, predicted values may be restricted to the determined limits according to another scheme—for example, the middle of the region between l[n] and u[n] may be assigned as p[n].

Each sample x[n] may have an associated p[n], l[n], and u[n] values. Traditional Huffman coding (and other prefix coding) schemes use a fixed alphabet of symbols to encode, however, in the illustrative embodiment of the invention, the alphabet may be different for each combination of p[n], l[n], and u[n]. The samples may be combined to share Huffman tables with other samples of similar ranges. Such combination may be performed by computing a “rank” t[n] for each prediction value p[n]. Rank computation is performed in act 413 and is further described in connection with FIGS. 5 and 6. One can also view the rank computation as a method to assign symbols with shorter Huffman prefixes to the more likely values of e[n]. Hence, the rank computation would assign 0 (a symbol with the shortest prefix) to e[n]=0; 1 and 2 (the next shortest prefixes) would be assigned to e[n]=1 and −1, etc. The present invention is not limited to Huffman or a particular type of prefix coding. In an alternative embodiment of the invention, a prefix coding scheme may be adapted to use different alphabets on ranges of similar size (such as, for example, by transmitting or storing the alphabet with the compressed data set). In yet another embodiment of the invention, a combination of prefix-coding and some other coding may be used.

Rank t[n] is then encoded using an appropriate Huffman table in act 414 and stored or transmitted, as appropriate for the particular implementation of the invention. Index n is then updated to the next value in act 415. A check is performed in act 416 in order to determine whether the whole frame has been encoded. If there are samples remaining to be encoded in the frame, the method proceeds back to acts 405 and 406 accordingly.

If all of the samples in a particular frame have been encoded, the compression process may proceed to other frames, as determined in act 417. The process of compression completes once all frames in a particular data set have been compressed.

The present invention is not limited to the process of compression as described above. The acts of the process may be performed in order different from what is described and may be augmented by additional acts, as deemed appropriate by one skilled in the art.

FIG. 5 is a flow chart illustrating rank computation. In an alternative embodiment of the invention, rank computation may be eliminated and computed e[n] values may be encoded using an alternative encoding scheme. In yet another embodiment of the invention, a mapping may be created between different alphabets in order to utilize the prefix coding schemes.

In the illustrative embodiment, computation of the rank starts in act 500, where variables p[n], l[n], u[n], and x[n] are initialized as appropriate. If the p[n] is equal to x[n], as determined in act 501, then the rank t[n] is set to 0 in act 502. Setting t[n] to 0 attempts to minimize encoding for the case where the predicted value is identical to the actual sampled value.

Variables distright [n] and distleft [n] are initialized, indicating distance between the predicted value p[n] and upper and lower bounds, accordingly. The main scheme is to assign values closest to p[n] to the lower digits, so that they may have shorter encodings. For example, x[n] with a rank of 10 means that it falls in the eleventh most likely location according to the predictor. Samples x[n] with lower ranks will therefore be assigned shorter entropy codes.

The details of a particular implementation may vary. In the illustrative embodiment, x[n] adjacent to the predicted value is assigned to the next lowest rank. The next lowest rank after that is in the direction of the closer edge first, or left if they are equal, as illustrated in acts 505 and 510.

There are three remaining regions of values defined by the ranking process. Region 1 is said to extend from predicted value to the nearer edge, which contains odd ranks (as illustrated in acts 506 and 511). Region 2 is a region of the same size as region 1, extending toward the further side, which contains even ranks, as illustrated in acts 508 and 513. Region 3 encompasses the rest of the values, which lie between Region 2 and the farthest edge and contains odd and even ranks, as illustrated in acts 509 and 514.

FIG. 6 is a schematic illustration of sample computed ranks. For example, for p[n]=6, and x[n]=8, the computed rank will be 4. That computed rank is then encoded using Huffman tables as described above. Ranks represent a function of p[n] and x[n], as well as limits, therefore they can be thought of as a representation of errors between p[n] and x[n]. For example, the larger the error, the larger the rank will be typically. The present invention is not limited to the rank calculation of the illustrative embodiment. Ranks, or other functions of p[n] and x[n] may be encoded as deemed appropriate by one skilled in the art.

FIG. 7 is a flow chart illustrating data decompression corresponding to the compression process described above. Typically decompression acts follow closely compression acts in order to recover the original dataset.

Decompression is initiated in act 700 and proceeds separately for each frame. Directions of constraints are decoded from the compressed data set in act 701. As described above, such directions may be indicated by a vector of bits, and a proper set of constraints may be selected based on those directions.

Values x[0] to x[K−1] are decoded in act 702. Those values correspond to sampled values that were encoded directly, without compression. If an alternative compression method is used for those values, the corresponding decompression scheme may be employed here. Correspondingly, n is assigned to be K in act 703.

Lower and upper bounds are computed in acts 704 and 705, correspondingly. These values may be computed using the same methodology as in the compression process. In an alternative embodiment of the invention, a different linear or non-linear programming methodology may be employed, so long as it guarantees to provide the same lower and upper bounds as in the compression scheme.

Range r[n] is defined in act 706, corresponding to the range in the compression process. If r[n] is larger than the predetermined range R, as determined in act 707, the corresponding value of x[n] is decoded in act 708. Otherwise, a Huffman table is selected in act 709 that corresponds to range r[n]. The Huffman table is selected according to the same methodology, as in the compression process.

Predicted value p[n] is predicted in act 710 using adaptive predictive scheme, as described above. Predicted value p[n] is then clipped to the determined limits in act 711. The rank t[n] is not computed in the decompression, because it requires knowledge of x[n]. Instead, it is decoded in act 712 according to the appropriate Huffman table from the compressed stream. Because the rank is a function of r[n], u[n], l[n], and x[n], and all variables except for x[n] are known at this point in the decompression, x[n] may be extracted from the t[n] in act 713. Extracting of x[n] from t[n] is described in further detail in connection with FIG. 8.

Furthermore, weights of the predictive functions j may be updated in act 713 after x[n] is extracted in order to have an indication of which predictive function to use for the next calculation.

The variable n is updated in act 714, and decompression proceeds to another sample, if decompressed samples are remaining in the frame, as determined in act 715. If the frame has been decompressed, it can be stored in act 716. In an alternative embodiment of the invention, decompression may be followed by playback, for example, such that the music track may be played to the user or processed in another manner while the decompression is proceeding on additional frames.

The decompression process completes if there are no compressed frames remaining, as determined in act 717, otherwise it proceeds to decompress additional frames.

FIG. 8 is a flow chart illustrating value extraction from rank t[n]. Value extraction follows closely rank encoding, described in connection with FIG. 5, repeating similar steps in order to extract x[n]. If rank t[n] is 0, as determined in act 801, x[n] is set to be identical to p[n] in act 802.

Variables distright [n] and distleft [n] are defined in act 803, as in corresponding rank-determining process. If distance to the upper bound is less than distance to the lower bound, as determined in act 804, odd values are determined as illustrated in acts 807 and 808, otherwise they are determined as illustrated in acts 812 and 813. Even values are determined as illustrated in acts 809 and 814, respectively. If x[n] is the value closest to p[n], it is determined in acts 806 and 811, correspondingly.

In such a way, x[n] may be extracted from rank t[n]. Value extraction is not limited to what is described above, and may be modified in any manner by one skilled in the art, as long as it produces the value x[n] based on at least a subset of values p[n], u[n], and l[n]. If rank calculation is not used in the compression, no value extraction may be necessary in the decompression process. In an alternative embodiment of the invention, where a different encoding scheme is used for unifying the alphabets for different r[n], a corresponding decoding scheme may be applied in decompression instead of the rank extraction described herein.

In general, any number of aspects of the compression and decompression may be modified by one skilled in the art. Compression and decompression need not follow similar patterns, so long as decompression is guaranteed to produce true values x[n] from a compressed data set, thus resulting in lossless compression and decompression.

The present invention is not limited to music or media data and may be applied to any kind of digital data, with limit calculations and predictive calculations modified accordingly.

It will be apparent to one skilled in the art that either one or both of compression and decompression modules and corresponding submodules may be implemented in software, hardware, or a combination of software or hardware. In an alternative embodiment of the invention either one or both compression or decompression may be combined with additional playback or analysis capabilities of the hardware or software performing compression or decompression.

An example of a compression or a decompression module may be, for example, a software program or agent, a software music or media player, a hardware module executing software instructions, a hardware module executing low-level instructions, hardware-only module, a state machine, or any combination of the above. Compression or decompression modules may be implemented as stand-alone modules or parts of a computer system.

A computer system for implementing the system of FIGS. 3, 4, and 7 as a computer program typically includes a main unit connected to both an output device that displays information to a user and an input device which receives input from a user. The main unit generally includes a processor connected to a memory system via an interconnection mechanism. The input device and output device also are connected to the processor and memory system via the interconnection mechanism.

It should be understood that one or more output devices may be connected to the computer system. Example output devices include a cathode ray tube (CRT) display, liquid crystal displays (LCD), printers, communication devices such as a modem, and audio output. It should also be understood that one or more input devices may be connected to the computer system. Example input devices include a keyboard, keypad, track ball, mouse, pen and tablet, communication device, and data input devices such as sensors. It should be understood the invention is not limited to the particular input or output devices used in combination with the computer system or to those described herein.

The computer system may be a general purpose computer system which is programmable using a computer programming language, such as C++, Java, or other language, such as a scripting language or assembly language. The computer system may also include specially programmed, special purpose hardware. In a general purpose computer system, the processor is typically a commercially available processor, of which the series x86 and Pentium processors, available from Intel, and similar devices from AMD and Cyrix, the 680X0 series microprocessors available from Motorola, the PowerPC microprocessor from IBM and the Alpha-series processors from Digital Equipment Corporation, are examples. Many other processors are available. Such a microprocessor executes a program called an operating system, of which WindowsNT, UNIX, DOS, VMS and OS8 are examples, which controls the execution of other computer programs and provides scheduling, debugging, input/output control, accounting, compilation, storage assignment, data management and memory management, and communication control and related services. The processor and operating system define a computer platform for which application programs in high-level programming languages are written.

A memory system typically includes a computer readable and writeable nonvolatile recording medium, of which a magnetic disk, a flash memory and tape are examples. The disk may be removable, known as a floppy disk, or permanent, known as a hard drive. A disk has a number of tracks in which signals are stored, typically in binary form, i.e., a form interpreted as a sequence of one and zeros. Such signals may define an application program to be executed by the microprocessor, or information stored on the disk to be processed by the application program. Typically, in operation, the processor causes data to be read from the nonvolatile recording medium into an integrated circuit memory element, which is typically a volatile, random access memory such as a dynamic random access memory (DRAM) or static memory (SRAM). The integrated circuit memory element allows for faster access to the information by the processor than does the disk. The processor generally manipulates the data within the integrated circuit memory and then copies the data to the disk when processing is completed. A variety of mechanisms are known for managing data movement between the disk and the integrated circuit memory element, and the invention is not limited thereto. It should also be understood that the invention is not limited to a particular memory system.

It should be understood the invention is not limited to a particular computer platform, particular processor, or particular high-level programming language. Additionally, the computer system may be a multiprocessor computer system or may include multiple computers connected over a computer network. It should be understood that each module (e.g. compression and decompression modules) may be separate modules of a computer program, or may be separate computer programs. Such modules may be operable on separate computers. Data (e.g. music data) may be stored in a memory system separate from some processor and connected to the processor through a network or transmitted between computer systems. The invention is not limited to any particular implementation using software or hardware or firmware, or any combination thereof. The various elements of the system, either individually or in combination, may be implemented as a computer program product tangibly embodied in a machine-readable storage device for execution by a computer processor. Various steps of the process may be performed by a computer processor executing a program tangibly embodied on a computer-readable medium to perform functions by operating on input and generating output. Computer programming languages suitable for implementing such a system include procedural programming languages, object-oriented programming languages, and combinations of the two.

Having now described several embodiments, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

All publications cited herein are hereby expressly incorporated by reference.

What is claimed is:

1. A computer-implemented method of lossless compression of a sequence of data points, said method comprising:
determining limits based on available data;
predicting value for a data point, wherein the predicted value is limited to the determined limits; and
encoding a function of the predicted value and the data point.

2. The method of claim 1, wherein the sequence of data points is a sequence of sampled continuous wave data points.

3. The method of claim 2, wherein the sequence of data points is a sequence of time-sampled music data.

4. The method of claim 1, wherein the available data is a subset of data points from the sequence of data points.

5. The method of claim 1, wherein determining limits further comprises determining limits on possible values of data based on a set of constraints satisfied by data values.

6. The method of claim 5, wherein the constraints are linear programming constraints, and determining limits comprises determining minimum and maximum values for the data point based on the linear programming constraints.

7. The method of claim 6, wherein determining limits further comprises selecting a set of linear programming constraints that are satisfied by the data point.

8. The method of claim 7, further comprising encoding the selected set of linear programming constraints.

9. The method of claim 1, wherein predicting the value for a data point comprises predicting the value based on the available data.

10. The method of claim 9, wherein predicting the value for a data point comprises selecting most likely value of the data point based on a subset of previously-processed data points from the sequence of data points.

11. The method of claim 10, wherein predicting the value for a data point comprises selecting a prediction function from a set of prediction functions.

12. The method of claim 11, wherein the set of prediction functions comprises a set of polynomial functions.

13. The method of claim 12, wherein selecting the prediction function further comprises selecting a prediction function that has performed best in predicting previously processed data points from the set of the data points.

14. The method of claim 13, further comprising updating information about performance of predictive functions in the set of predictive functions.

15. The method of claim 1, wherein the function of the predicted value and the data point is a difference between the predicted value and the data point.

16. The method of claim 16, wherein encoding the difference further comprises encoding the difference using a prefix coding table according to the prefix coding scheme.

17. The method of claim 16, wherein encoding the difference further comprises computing a rank of the difference.

18. The method of claim 17, wherein encoding the difference further comprises selecting a prefix table from a set of available prefix tables, based on the determined limits.

19. The method of claim 1, further comprising performing an act of determining limits for a second data point and encoding the second data point if a range of the determined limits is larger than a predetermined range.

20. The method of claim 16, wherein encoding further comprises selecting an encoding scheme from a set of available encoding schemes.

21. A computer-implemented method of decompressing a compressed sequence of data points, said method comprising:
determining limits based on available data;
predicting value for a data point, wherein the predicted value is within the determined limits;
decoding an encoded function of the predicted value and a data point;
obtaining the data point from the function of the predicted value and the data point.

22. The method of claim 21, wherein the sequence of data point is a sequence of sampled continuous wave data points.

23. The method of claim 22, wherein the sequence of data points is a sequence of time-sampled music data.

24. The method of claim 21, wherein the available data is a subset of obtained data points from the sequence of data points.

25. The method of claim 21, wherein determining limits further comprises determining limits on possible values of data based on a set of constraints satisfied by data values.

26. The method of claim 25, wherein determining limits further comprises selecting the set of constraints based on an encoded selector.

27. The method of claim 26, wherein the constraints are linear programming constraints, and determining limits further comprises determining minimum and maximum values for the data point based on the linear programming constraints.

28. The method of claim 27, wherein the selector indicates one of two possible sets of linear programming constraints.

29. The method of claim 21, wherein predicting the value for a data point comprises predicting the value based on the available data.

30. The method of claim 29, wherein predicting the value for a data point comprises selecting most likely value of the data point based on a subset of obtained data points from the set of data points.

31. The method of claim 30, wherein predicting the value for a data point comprises selecting a prediction function from a set of prediction functions.

32. The method of claim 31, wherein the set of prediction functions comprises a set of polynomial functions.

33. The method of claim 32, wherein selecting the prediction function further comprises selecting a prediction function that has performed best in predicting a second subset of obtained data points from the set of the data points.

34. The method of claim 33, further comprising updating information about performance of predictive functions in the set of predictive functions.

35. The method of claim 29, further comprising limiting the predicted value to one of the determined limits.

36. The method of claim 21, wherein the function of the predicted value and the data point is a difference between the predicted value and the data point.

37. The method of claim 36, wherein decoding the encoded function further comprises decoding the difference using a prefix coding table according to the prefix coding scheme.

38. The method of claim 37, wherein decoding the difference further comprises selecting a prefix table from a set of available prefix coding tables based on the determined limits.

39. The method of claim 36, wherein decoding further comprises selecting a decoding scheme from a set of available decoding schemes.

40. The method of claim 21, further comprising performing an act of determining limits for a second data point and decoding the second data point if a range of the determined limits is larger than a predetermined range.

41. A system for lossless compression of a sequence of data points, said system comprising:
a limit module for determining limits based on available data;
a predictor for predicting a value for a data point, wherein the predicted value is limited to the determined limits; and
an encoder for encoding a function of the predicted value and the data point.

42. The system of claim 41, wherein the limit module is a linear programming module for determining the limits based on a set of linear constraints satisfied by the data point.

43. The system of claim 42, wherein the set of linear constraints is selected from available sets of linear constraints.

44. The system of claim 43, wherein the encoder further encodes the selected set of linear constraints.

45. The system of claim 42, wherein the limits are a minimum and a maximum values satisfying the linear constraints.

46. The system of claim 41, wherein the predictor predicts value for the data point based on a subset of previously-processed data points from the set of data points.

47. The system of claim 46, wherein the predictor computes a polynomial function.

48. The system of claim 47, wherein the polynomial function is selected from a set of polynomial functions based on prior predictive performance on a subset of data points from the set of data points.

49. The system of claim 41, wherein the encoder is a prefix encoder encoding the function of the predicted value and the data point based on a prefix coding table.

50. The system of claim 49, wherein the system further comprises a stored set of prefix coding tables from which the encoder selects a prefix coding table based on a range of the determined limits.

51. The system for decompression of a sequence of data points, said system comprising:
a limit module for determining limits based on available data;
a predictor for predicting a value for a data point, wherein the predicted value is limited to the determined limits; and
a decoder for decoding a data point based on an encoded function of the predicted value and the data point.

52. The system of claim 5 1, wherein the limit module is a linear programming module for determining the limits based on a set of linear constraints satisfied by the data point.

53. The system of claim 52, wherein the set of linear constraints is one of available sets of linear constraints that is satisfied by the data point.

54. The system of claim 53, wherein the decoder further decodes a selector indicating the set of linear constraints.

55. The system of claim 52, wherein the limits are a minimum and a maximum values satisfying the linear constraints.

56. The system of claim 51, wherein the predictor predicts value for the data point based on a subset of previously-decoded data points from the set of data points.

57. The system of claim 56, wherein the predictor computes a polynomial function.

58. The system of claim 57, wherein the polynomial function is selected from a set of polynomial functions based on prior predictive performance on a subset of data points from the set of data points.

59. The system of claim 51, wherein the decoder is a prefix decoder decoding the function of the predicted value and the data point based on a prefix coding table.

60. The system of claim 49, wherein the system further comprises a stored set of prefix coding tables from which the decoder selects a prefix coding table based on a range of the determined limits.

61. A stream of data, comprising data points encoded by:
determining limits based on available data;
predicting value for a data point, wherein the predicted value is limited to the determined limits; and
encoding a function of the predicted value and the data point.

62. The stream of data of claim 61, wherein the sequence of data points is a sequence of sampled continuous wave data points.

63. The stream of data of claim 62, wherein the sequence of data points is a sequence of time-sampled music data.

64. The stream of data of claim 61, wherein the available data is a subset of data points from the sequence of data points.

65. The stream of data of claim 61, wherein determining limits further comprises determining limits on possible values of data based on a set of constraints satisfied by data values.

66. The stream of data of claim 65, wherein the constraints are linear programming constraints, and determining limits comprises determining minimum and maximum values for the data point based on the linear programming constraints.

67. The stream of data of claim 66, wherein determining limits further comprises selecting a set of linear programming constraints that are satisfied by the data point.

68. The stream of data of claim 67, further comprising encoding the selected set of linear programming constraints.

69. The stream of data of claim 61, wherein predicting the value for a data point comprises predicting the value based on the available data.

70. The stream of data of claim 69, wherein predicting the value for a data point comprises selecting most likely value of the data point based on a subset of previously-processed data points from the sequence of data points.

71. The stream of data of claim 70, wherein predicting the value for a data point comprises selecting a prediction function from a set of prediction functions.

72. The stream of data of claim 71, wherein the set of prediction functions comprises a set of polynomial functions.

73. The stream of data of claim 72, wherein selecting the prediction function further comprises selecting a prediction function that has performed best in predicting previously processed data points from the set of the data points.

74. The stream of data of claim 73, further comprising updating information about performance of predictive functions in the set of predictive functions.

75. The stream of data of claim 69, further comprising restricting the predicted value to one of the determined limits.

76. The stream of data of claim 61, wherein the function of the predicted value and the data point is a difference between the predicted value and the data point.

77. The stream of data of claim 76, wherein encoding the difference further comprises encoding the difference using a prefix coding table according to the prefix coding scheme.

78. The stream of data of claim 77, wherein encoding the difference further comprises selecting a prefix coding table from a set of available prefix coding tables, based on the determined limits.

79. The stream of data of claim 61, further comprising performing an act of determining limits for a second data point and encoding the second data point if a range of the determined limits is larger than a predetermined range.

80. The stream of data of claim 76, wherein encoding further comprises selecting an encoding scheme from a set of available encoding schemes.

81. A system for lossless compression of a sequence of data points, said system comprising:
means for determining limits based on available data;
means for predicting a value for a data point, wherein the predicted value is limited to the determined limits; and
means for encoding a function of the predicted value and the data point.

82. The system of claim 81, wherein the means for determining limits is a linear programming means for determining the limits based on a set of linear constraints satisfied by the data point.

83. The system of claim 82, wherein the means for determining limits further comprise means for selecting the set of linear constraints from available sets of linear constraints.

84. The system of claim 83, wherein the means for encoding further comprises means for encoding the selected set of linear constraints.

85. The system of claim 82, wherein the limits are a minimum and a maximum values satisfying the linear constraints.

86. The system of claim 81, wherein the means for predicting further comprises means for predicting value for the data point based on a subset of previously-processed data points from the set of data points.

87. The system of claim 86, wherein the means for predicting further comprise means for computing a polynomial function.

88. The system of claim 87, wherein means for predicting further comprise means for selecting the polynomial function from a set of polynomial functions based on prior predictive performance on a subset of data points from the set of data points.

89. The system of claim 81, wherein the means for encoding further comprise means for prefix encoding the function of the predicted value and the data point based on a prefix coding table.

90. The system of claim 89, wherein the system further comprises a stored set of prefix coding tables and means for selecting the prefix coding table based on a range of the determined limits.

91. A system for decompression of a sequence of data points, said system comprising:
means for determining limits based on available data;
means for predicting a value for a data point, wherein the predicted value is limited to the determined limits; and
means for decoding the data point based on an encoded function of the predicted value and the data point.

92. The system of claim 91, wherein the means for determining limits is a linear programming means for determining the limits based on a set of linear constraints satisfied by the data point.

93. The system of claim 92, wherein the means for determining limits further comprise means for selecting the set of linear constraints from available sets of linear constraints.

94. The system of claim 93, wherein the means for decoding further comprises means for decoding a selector indicating the selected set of linear constraints.

95. The system of claim 92, wherein the limits are a minimum and a maximum values satisfying the linear constraints.

96. The system of claim 91, wherein the means for predicting further comprises means for predicting value for the data point based on a subset of previously-processed data points from the set of data points.

97. The system of claim 96, wherein the means for predicting further comprise means for computing a polynomial function.

98. The system of claim 97, wherein means for predicting further comprise means for selecting the polynomial function from a set of polynomial functions based on prior predictive performance on a subset of data points from the set of data points.

99. The system of claim 91, wherein the means for decoding further comprise means for prefix decoding the function of the predicted value and the data point based on a prefix coding table.

100. The system of claim 99, wherein the system further comprises a stored set of prefix coding tables and means for selecting the prefix coding table based on a range of the determined limits.

101. A method for encoding data, said method comprising:
determining a range of values of a data point;
selecting a prefix table based on the determined range from a set of prefix tables; and
encoding a function of the data point according to the selected prefix table.

102. The method of claim 101, wherein determining a range further comprises solving a linear program in order to determine a minimum and a maximum values satisfied by linear constraints.

102. A method for lossless encoding of a stream of data points comprising time-sampled music data, said method comprising:
determining limits based on available data;
performing intra-channel decorrelation on a data point;
limiting results of the intra-channel decorrelation to the determined limits; and
encoding results of the intra-channel decorrelation.

103. The method of claim 103, wherein determining limits further comprises determining a set of constraints satisfied by the data point.

104. The method of claim 103, wherein the constraints are linear constraints and determining limits further comprises solving a linear program in order to determine a minimum and a maximum value satisfied by the linear constraints.

105. The method of claim 103, wherein performing intra-channel decorrelation further comprises predicting value for the data point based on at least one previously processed data point.

106. The method of claim 106, wherein predicting the value further comprises predicting the value according to a polynomial function.

107. The method of claim 107, wherein predicting the value further comprises selecting the polynomial function from a set of available polynomial functions based on prior performance of functions in the set of polynomial functions.

108. The method of claim 103, wherein encoding results of the intra-channel decorrelation further comprises encoding the results based on a prefix coding table.

109. The method of claim 109, wherein encoding the results further comprises selecting the prefix coding table from a set of available prefix coding tables based on the determined limits.

110. A data stream created by a method of lossless compression of a sequence of data points, said method comprising:
determining limits based on available data;
predicting value for a data point, wherein the predicted value is limited to the determined limits; and
encoding a function of the predicted value and the data point.

111. The method of claim 110, wherein the sequence of data points is a sequence of sampled continuous wave data points.

112. The method of claim 111 , wherein the sequence of data points is a sequence of time-sampled music data.

113. The method of claim 110, wherein the available data is a subset of data points from the sequence of data points.

114. The method of claim 110, wherein determining limits further comprises determining limits on possible values of data based on a set of constraints satisfied by data values.

115. The method of claim 114, wherein the constraints are linear programming constraints, and determining limits comprises determining minimum and maximum values for the data point based on the linear programming constraints.

116. The method of claim 110, wherein predicting the value for a data point comprises selecting most likely value of the data point based on a subset of previously-processed data points from the sequence of data points.

117. The method of claim 116, wherein predicting the value for a data point comprises selecting a prediction function from a set of prediction functions.

118. The method of claim 117, further comprising restricting the predicted value to one of the determined limits.
